(19) United States
(12) Patent Application Publication
(10) Pub. No.: US 2007/0296727 A1
(43) Pub. Date: Dec. 27, 2007

(54) Information processing apparatus and display control method

(76) Inventor: Masanobu Kumakawa, Hidaka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/820,356

(22) Filed: Jun. 19, 2007

(30) Foreign Application Priority Data
Jun. 21, 2006 (JP) 2006-171855

(51) Int. Cl. G06F 13/14

(52) U.S. Cl. 345/520

(57) ABSTRACT

According to one embodiment, an information processing apparatus including a connector, a determination unit configured to determine whether a display device, which is connected via the connector, is adaptive to an underscan display scheme or an overscan display scheme, and a setting unit configured to set one of underscan and overscan as an output scheme of display data to the display device, based on a determination result by the determination unit.

### CROSS-REFERENCE TO RELATED APPLICATIONS

This application is based upon and claims the benefit of priority from Japanese Patent Application No. 2006-171855, filed Jun. 21, 2006, the entire contents of which are incorporated herein by reference.

### BACKGROUND

1. Field

One embodiment of the invention relates to a display control technique for an information processing apparatus having a connector for outputting display data, which is connectable to, for example, a display device according to the HDMI (High-Definition Multimedia Interface) standard and a display device according to the DVI (Digital Visual Interface) standard.

2. Description of the Related Art

In recent years, personal computers having high-level video processing functions, which enables viewing/listening and recording of TV broadcast and playback of DVDs (Digital Versatile Disks), have been steadily gaining in popularity. Along with this trend, in order to enjoy viewing high-quality video, general use has been made of a display device capable of displaying high-definition images, which is externally connected to, e.g. a notebook personal computer having a built-in LCD (Liquid Crystal Display) (despite the personal computer being equipped with the LCD).

With such an increasing demand for enjoying high-quality video, various techniques for enabling more convenient display have been proposed, such as a technique of automatically switching a display scheme in accordance with display content so that a computer screen image is displayed by underscan and a DVD image is displayed by overscan at a time of playback (see, e.g. Jpn. Pat. Appln. KOKAI Publication No. 2005-345523).

Connectors for connection to display devices include, for instance, a D terminal for connection to a TV apparatus, and a D-sub15pin terminal and a DVI terminal for connection to computer monitors. Conventionally, display control is normally executed in accordance with the kind of the terminal. For example, overscan-adaptive display is executed for a display device (TV apparatus) which is connected via the D terminal, and underscan-adaptive display is executed for a display device (computer monitor) which is connected via the D-sub15pin terminal or DVI terminal.

However, with the advent of HDMI-terminal-equipped TV apparatuses and the presence of HDMI-DVI conversion cables and DVI-HDMI conversion cables, there is no longer one-to-one correspondence between the terminal and the display device. In other words, since the HDMI-terminal-equipped TV apparatus can be connected to the DVI terminal (via the DVI-HDMI conversion cable) or the DVI monitor can be connected to the HDMI terminal (via the HDMI-DVI conversion cable), the above-described display control based on the terminal-by-terminal basis is no longer a proper method. Under the circumstances, there is a strong demand for a novel scheme for automatically executing an optimal display control, without making the user conscious of the display control.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an exemplary system configuration of an information processing apparatus according to an embodiment of the invention;

FIG. 2 is an exemplary functional block diagram for explaining an operational principle relating to image display of the information processing apparatus according to the embodiment;

FIG. 3A and FIG. 3B show, by way of example, the shape of a monitor and data to be displayed on the monitor, there by explain underscan and overscan;

FIG. 4 shows various examples of display of image data shown in FIG. 3B, which is displayed on the monitor having the shape shown in FIG. 3A;

FIGS. 5A, 5B, 5C and 5D show possible modes of connection between a DVI terminal and an HDMI terminal, on the one hand, and a DVI monitor and an HDMI-terminal-equipped TV apparatus, on the other hand;

FIG. 6 shows an example of a setup screen which is displayed by a setup unit of a system BIOS which runs on the information processing apparatus according to the embodiment; and

FIG. 7 is an exemplary flow chart illustrating the operational procedure of an automatic setup process of a display data output scheme (underscan or overscan) which is executed by a display driver of the system BIOS which runs on the information processing apparatus according to the embodiment.

### DETAILED DESCRIPTION

Various embodiments according to the invention will be described hereinafter with reference to the accompanying drawings. In general, according to one embodiment of the invention, an information processing apparatus including a connector, a determination unit configured to determine whether a display device, which is connected via the connector, is adaptive to an underscan display scheme or an overscan display scheme, and a setting unit configured to set one of underscan and overscan as an output scheme of display data to the display device, based on a determination result by the determination unit.

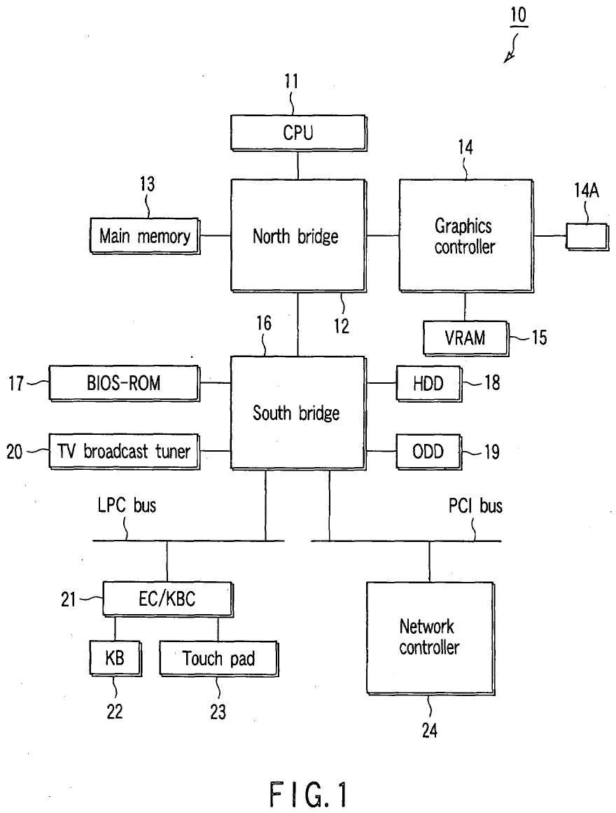

FIG. 1 shows an exemplary system configuration of the information processing apparatus according to the embodiment of the invention. This information processing apparatus is realized, for example, as a desktop personal computer 10.

As shown in FIG. 1, the computer 10 comprises a CPU 11, a north bridge 12, a main memory 13, a graphics controller 14, a connector 14A, a video RAM 15, a south bridge 16, a BIOS (Basic Input/Output System)-ROM 17, a magnetic disk drive (HDD) 18, an optical disc drive (ODD) 19, a TV broadcast tuner 20, an embedded controller/keyboard controller IC (EC/KBC) 21, a keyboard 22, a touch pad 23 and a network controller 24.

The CPU 11 is a processor that controls the operation of the computer 10. The CPU 11 executes an operating system and various application programs including a utility, which are loaded from the HDD 18 into the main memory 13. The various application programs include business software for creating a document or performing spreadsheet tabular calculations, and entertainment software for viewing/listening to TV broadcast which is received by the TV broadcast tuner 20 and reproducing content on a DVD that is loaded in the ODD 19. The programs, which are loaded from the HDD 18 into the main memory 13 and are executed by the CPU 11, include a display driver for controlling the driving of the graphic controller 14. Further, the CPU 11 also executes a system BIOS that is stored in the BIOS-ROM 17. The system BIOS is a program for hardware control.

The north bridge 12 is a bridge device that connects a local bus of the CPU 11 and the south bridge 16. In addition, the north bridge 12 includes a memory controller for access-controlling the main memory 13.

The graphics controller 14 is a display controller which controls a display device that is connected via the connector 14A. The VRAM 15 is a memory device which is used as a working area when the graphics controller 14 generates video data.

The south bridge 16 controls devices on an LPC (Low Pin Count) bus and devices on a PCI (Peripheral Component Interconnect) bus. The south bridge 16 includes an IDE (Integrated Drive Electronics) controller for controlling the HDD 18. The TV broadcast tuner 20 is a tuner module for receiving a TV signal of a specified channel.

The EC/KBC 21 is a 1-chip microcomputer in which an embedded controller for power management and a keyboard controller for controlling the keyboard 22 and touch pad 23 are integrated. The network controller 24 is a communication device for executing, e.g. IEEE 802.11 standard wireless communication or IEEE 1394 standard serial bus communication.

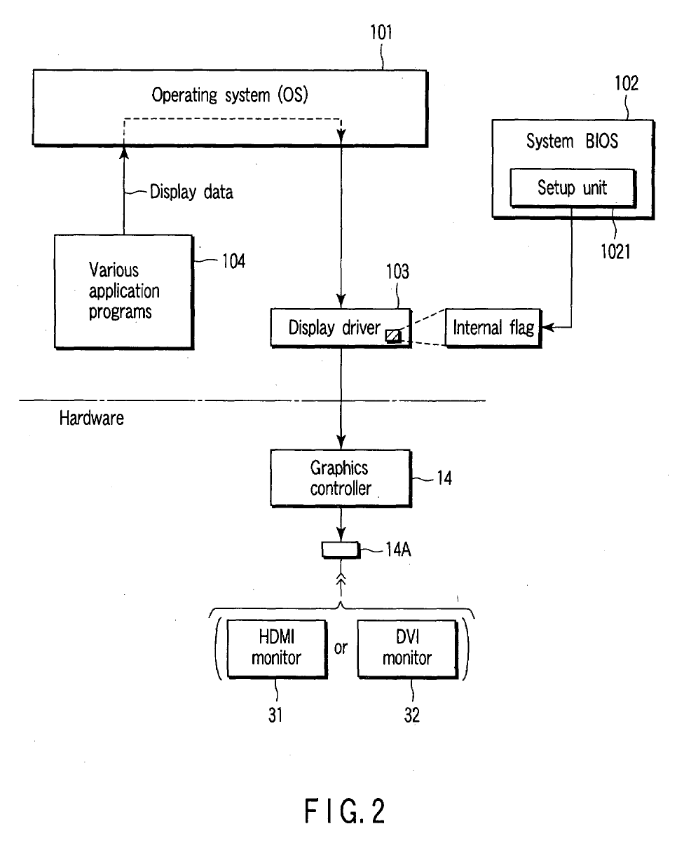

FIG. 2 is an exemplary functional block diagram for explaining an operational principle relating to image display of the computer 10 having the above-described structure.

An image display request from various application programs 104 is sent to a display driver 103 via an operating system 101. Upon receiving the image display request, the display driver 103 controls the driving of the graphics controller 14 so as to output display data, which is received from the application programs 104, to the display device. At this time, the display driver 103 outputs the display data according to an output scheme corresponding to underscan or overscan, on the basis of the value of an internal flag that is held in the display driver 103.

In order to set the value of the internal flag, a system BIOS 102 includes a setup unit 1021. The setup unit 1021 provides an interface which enables a user to arbitrarily set up the system environment of the computer 10. One of the setup items is a setup item for setting underscan or overscan as a display data output scheme for outputting display data to the display device.

This setup item provides a choice for fixedly setting underscan or overscan, and a choice for causing the computer to automatically set one of underscan and overscan. If the automatic setting is chosen, the display driver 103 determines which of underscan and overscan is proper, and sets an internal flag, thus controlling the graphics controller 14.

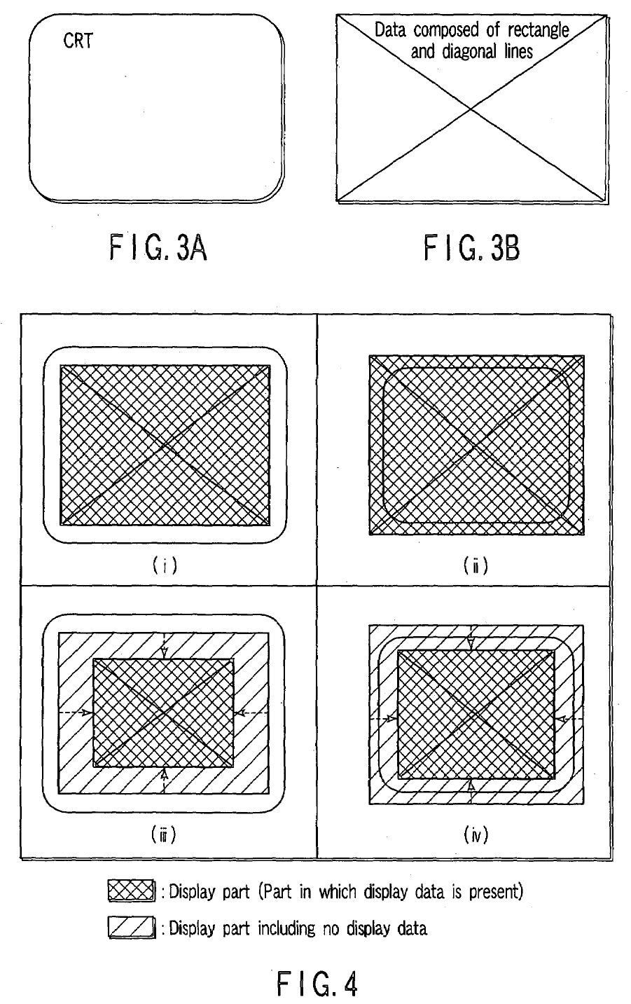

Referring to FIG. 3A, FIG. 3B and FIG. 4, the “underscan” and “overscan” are explained. It is assumed that the underscan and overscan refer to display schemes which are executed on the display device (monitor) side.

Assume now that image data, which is composed of a rectangle and diagonal lines as shown in FIG. 3B, is to be displayed on a CRT monitor having a shape shown in FIG. 3A.

In this case, “underscan” means a display mode in which image data is displayed by scanning the inside range of the CRT monitor screen, without scanning the outside area of the CRT monitor screen, as shown in parts (i) and (iii) of FIG. 4. In usual cases, a monitor for a personal computer displays all data within the CRT screen by underscan. Thus, the monitor screen of the personal computer is designed on the presupposition that data is displayed by underscan. The monitor screen of the personal computer is, for example, a desktop screen of the operating system 101.

On the other hand, “overscan” means a display mode in which image data is displayed by scanning the range including the outside area of the CRT monitor screen, as shown in parts (ii) and (iv) of FIG. 4. In usual cases, TV broadcast is displayed by overscan, and the range of video data is greater than the range of the CRT screen, and image data corresponding to the outside area of the screen is invisible.

Taking the above into account, “underscan-adaptive display” means that underscan display is effected on a monitor that is designed for underscan, as shown in part (i) of FIG. 4. On the other hand, “overscan-adaptive display” means that a screen image of a personal computer, which has a size smaller than the scan range, is displayed on a monitor that is designed for overscan, whereby the screen image of the personal computer is displayed within the screen of the CRT monitor as if “underscan” is executed.

It is assumed that the connector 14A, which is provided on the computer 10, is one of the DVI terminal and the HDMI terminal. The DVI is an interface standard for digital displays, which was made public in 1999 by the DDWG (Digital Display Working Group). On the other hand, the HDMI is a digital video/audio input/output interface standard mainly for household electric appliances and AV equipment, which was formulated in December 2002. The HDMI is a standard developed from the DVI. In the HDMI standard, video, audio and control signals are combined and transmitted over a single cable, and thus wiring can be made simpler. In addition, control signals can optionally be transmitted in two opposite directions, and a plurality of AV devices can be controlled from a single remote controller by relaying the devices.

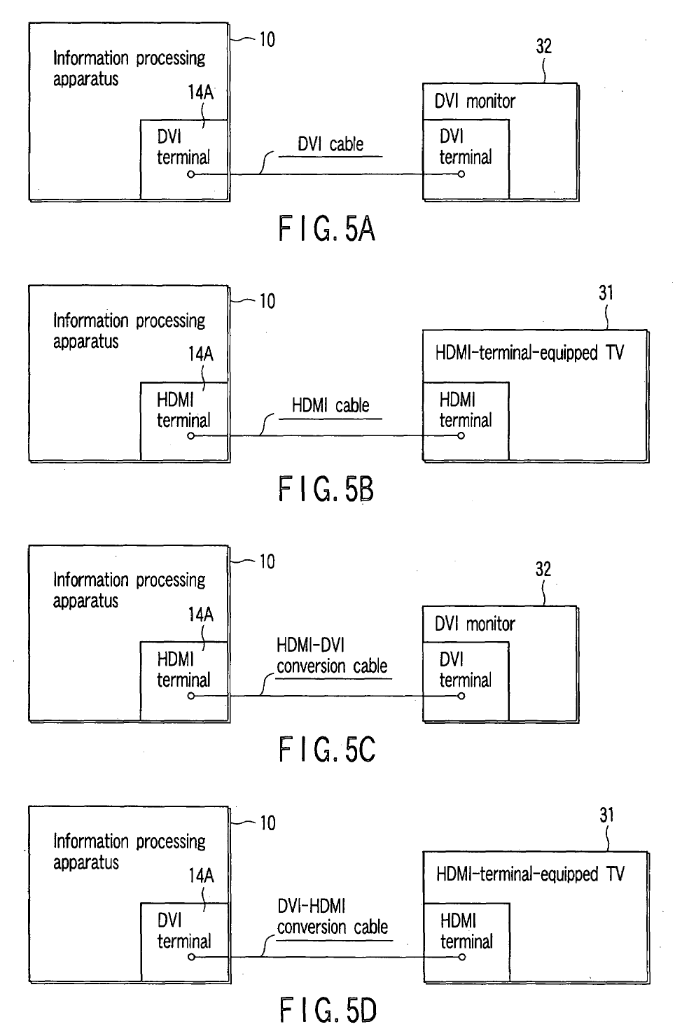

In the meantime, even in the case where the connector 14A is a DVI terminal, an HDMI monitor can be connected to the connector 14A by using a DVI-HDMI conversion cable. In addition, even in the case where the connector 14A is an HDMI terminal, a DVI monitor can be connected to the connector 14A by using an HDMI-DVI conversion cable. Accordingly, four connection modes are possible, as shown in FIGS. 5A, 5B, 5C and 5D.

To be more specific, the following four connection modes are thinkable: (1) DVI terminal-(DVI cable)-DVI monitor (FIG. 5A), (2) HDMI terminal-(HDMI cable)-HDMI-terminal-equipped TV apparatus (FIG. 5B), (3) HDMI terminal-(HDMI-DVI conversion cable)-DVI monitor (FIG. 5C), and (4) DVI terminal-(DVI-HDMI conversion cable)-HDMI-terminal-equipped TV apparatus (FIG. 5D).

Specifically, as shown in FIG. 2, an HDMI-terminal-equipped TV apparatus (HDMI monitor) 31 and a DVI monitor 32 can be connected to the connector 14A. If the DVI monitor 32 is connected to the connector 14A, it is preferable to execute underscan-adaptive display. In the case where the HDMI monitor 31 is connected to the connector 14A, if the HDMI monitor 31 supports underscan, it is preferable to execute underscan-adaptive display, and if the HDMI monitor 31 does not support underscan, it is preferable to execute overscan-adaptive display.

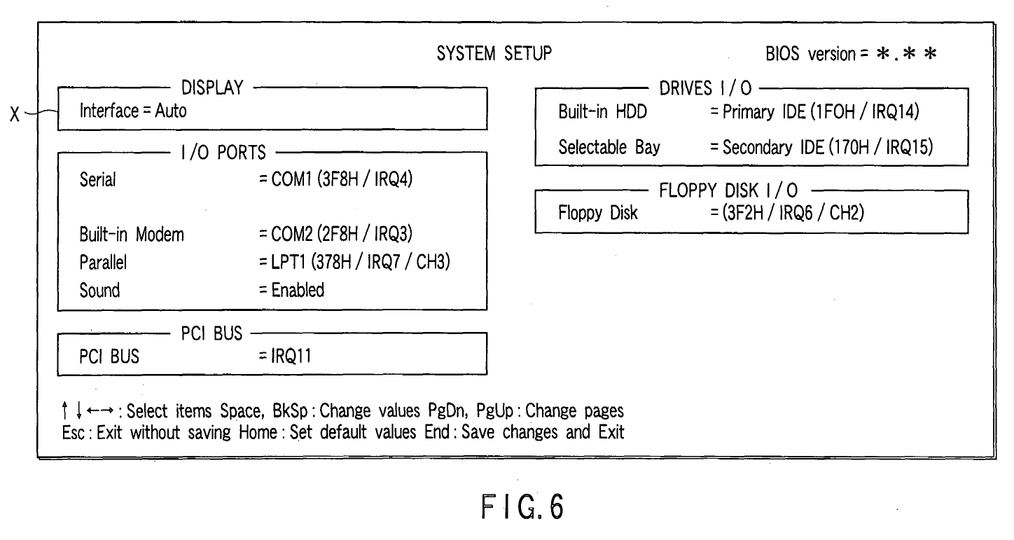

Hence, the setup unit 1021 of the system BIOS 102 is configured to enable the user to select underscan or overscan as a display data output scheme for outputting display data to the monitor. FIG. 6 shows an example of the setup screen which is displayed by the setup unit 1021.

A field x on the setup screen shown in FIG. 6 is a field for setting the display data output scheme for outputting display data to the monitor. In the field .x, one of underscan and overscan can be selected. In addition, “Auto” can be selected, as shown in FIG. 6, thereby to cause the computer 10 to automatically set one of underscan and overscan. In other words, this automatic setup function can be turned off by setting a choice other than “Auto” in the field x.

In this computer 10, one of underscan and overscan is not fixedly set in accordance with the kind of the output terminal. One of underscan and overscan can automatically be set on the basis of information that is obtained from the connected display device. This point is described below in detail.

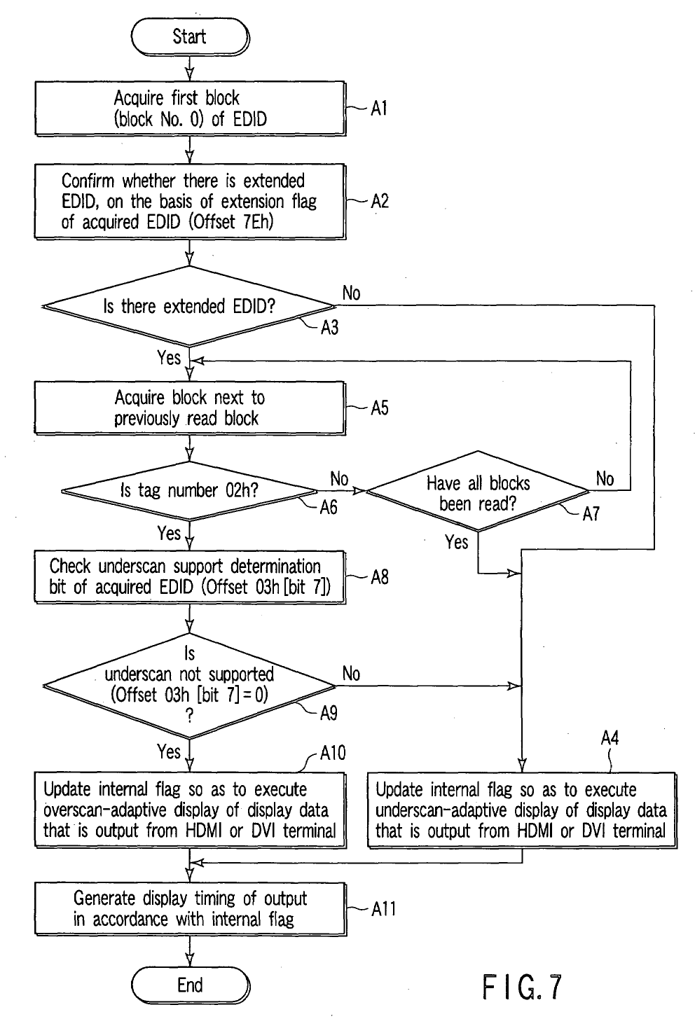

FIG. 7 is an exemplary flow chart illustrating the operational procedure of the automatic setup process of the display data output scheme (underscan or overscan) which is executed by the display driver 103.

In the case where the monitor output setup by the setup unit 1021 is “Auto”, the display driver 103 initially acquires EDID (Extended Display Identification Data), which is display support information, from an (output) destination device, that is, the monitor, prior to outputting display data via a digital interface such as an HDMI terminal (block A1). This process is executed in order to determine the output timing of display data.

Since this initially acquired EDID includes information (Extension Flag) which indicates whether the device has an extended EDID (Offset 7Eh), the display driver 103 determines whether there is the extended EDID or not, on the basis of the value of the Extension Flag (block A2).

An HDMI monitor is required to support the extended EDID, namely, CEA EDID Timing Extension. Specifically, if there is no extended EDID (No in block A3), it is found that the monitor does not support the HDMI standard. In the case where the HDMI standard is not supported, the display driver 103 determines that the monitor is a DVI monitor.

Most of monitors, which are connected via a DVI interface, are monitors for personal computers (PCs). Thus, the display driver 103 executes underscan-adaptive display. In this case, the display driver 103 sets an internal flag which indicates underscan-adaptive display, and executes setting to perform underscan-adaptive display for display data which is output from the HDMI or DVI terminal (block A4).

On the other hand, if the display driver 103 has determined that the extended EDID is present, on the basis of the value of the Extension Flag (Yes in block A3), the display driver 103 successively reads out blocks of extended EDID until the extended EDID of Tag02h is obtained, since the CEA EDID Timing Extension is stored in the second or following block (block number 1 or a subsequent block number) in a data sequence beginning with 02h(Tag) (block A5 to block A7).

If the CEA EDID Timing Extension cannot be read out (No in block A6, Yes in block A7), the display driver 103 also determines that the display device does not support the HDMI standard, and executes setting to perform underscan-adaptive display (block A4).

If the CEA EDID Timing Extension is acquired (Yes in block A6), the display driver 103 checks an Underscan support flag which is defined at Bit7 of Offset03h (block A8). In Version1 of the CEA EDID Timing Extension, this bit is undefined (Reserved), but an obligation to set 00h is stipulated. In Version1, it is not clear whether the underscan is supported or not, and thus it is determined that underscan is not supported. Since the set value of bit7 is 0, the same value, as in the case where underscan is not supported in Version2 or the following Versions, is read. Thus, in the present case, the Version of the CEA EDID Timing Extension is not particularly checked.

Then, the display driver 103 determines whether the Underscan support flag, which is defined at Bit7 of Offset03h of the CEA EDID Timing Extension(Tag02h), is 0 or not (block A9). If the Underscan support flag is 0 (Yes in block A9), overscan-adaptive display is executed since underscan is not supported by the HDMI monitor. In this case, the display driver 103 sets the internal flag which indicates execution of overscan-adaptive display, and the display mode of output data from the HDMI or DVI terminal is set to the overscan-adaptive display (block A10).

If the Underscan support flag is not 0 (No in block A9), underscan-adaptive display is executed since underscan is supported by the HDMI monitor. In this case, the display driver 103 sets the internal flag which indicates execution of underscan-adaptive display, and the display mode of output data from the HDMI or DVI terminal is set to the underscan-adaptive display (block A4).

The display driver 103 generates and outputs a display timing in accordance with the internal flag set in block A4 or block A10 (block A11).

In short, the display driver 103 realizes the following automatic setting. That is, based on the display support information acquired from the monitor, the display driver 103 checks whether the HDMI standard is supported by the monitor. If the HDMI standard is not supported by the monitor, the display driver 103 determines that the monitor is a DVI monitor, and executes underscan-adaptive display. If the HDMI standard is supported by the monitor, the display driver 103 further checks whether underscan is supported by the monitor. If underscan is supported, the display driver 103 executes underscan-adaptive display, and if underscan is not supported, the display driver 103 executes overscan-adaptive display.

As has been described above, the computer 10 realizes automatic setting of either display corresponding to underscan or display corresponding to overscan for a display monitor that is connected via the connector 14A, without making a user conscious of such setting.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a connector; and
a determination unit configured to determine whether a display device, which is connected via the connector, is adaptive to an underscan display scheme or an overscan display scheme; and
a setting unit configured to set one of underscan and overscan as an output scheme of display data to the display device, based on a determination result by the determination unit.

2. The information processing apparatus according to claim 1, wherein the determination unit determines whether the display device is adaptive to the underscan display scheme or the overscan display scheme, based on display support information which is acquired from the display device in order to determine an output timing of display data.

3. The information processing apparatus according to claim 2, wherein the determination unit determines that the display device is adaptive to the underscan display scheme in a case where information indicating whether the display device is adaptive to the underscan display scheme or the overscan display scheme is not acquired from the display support information.

4. The information processing apparatus according to claim 1, further comprising an environment setup unit configured to set operation/non-operation of the determination unit and the setting unit.

5. An information processing apparatus comprising:
a connector;
a first determination unit configured to determine whether a display device, which is connected via the connector, supports an HDMI (High-Definition Multimedia Interface) standard;
a second determination unit configured to determine, in a case where the first determination unit has determined that the display device supports the HDMI standard, whether the display device is adaptive to an underscan display scheme; and
a setting unit configured to set underscan as an output scheme of display data to the display device, in a case where the first determination unit has determined that the display device does not support the HDMI standard and in a case where the first determination unit has determined that the display device supports the HDMI standard and the second determination unit has determined that the display device is adaptive to the underscan display scheme, and to set overscan as the output scheme of display data to the display device, in a case where the first determination unit has determined that the display device supports the HDMI standard and the second determination unit has determined that the display device is not adaptive to the underscan display scheme.

6. The information processing apparatus according to claim 5, wherein the first determination unit determines support/non-support of a Consumer Electronics Association (CEA) Extended Display Identification Data (EDID) Timing Extension based on a value of an Extension Flag in an EDID which is acquired from the display device in order to determine an output timing of display data, and the first determination unit determines that the display device does not support the HDMI standard in a case where the CEA EDID Timing Extension is not supported.

7. The information processing apparatus according to claim 6, wherein the first determination unit determines that the display device does not support the HDMI standard in a case where the first determination unit has determined that the CEA EDID Timing Extension is supported based on the value of Extension Flag but a data string of the CEA EDID Timing Extension has not been obtained.

8. The information processing apparatus according to claim 7, wherein the second determination unit determines whether the display device is adaptive to the underscan display scheme, based on a value of an Underscan Support Flag in the CEA EDID Timing Extension.

9. The information processing apparatus according to claim 5, further comprising an environment setup unit configured to set operation/non-operation of the first determination unit, the second determination unit and the setting unit.

10. A display control method for an information processing apparatus to which a display device is externally connected, comprising:
determining whether the display device is adaptive to an underscan display scheme or an overscan display scheme; and
setting one of underscan and overscan as an output scheme of display data to the display device, on the basis of a result of the determination.
